(19) United States
(12) Patent Application Publication
(10) Pub. No.: US 2012/0058414 A1
(43) Pub. Date: Mar. 8, 2012

(54) METHOD FOR PREPARING MEMBRANE-ELECTRODE ASSEMBLY, MEMBRANE-ELECTRODE ASSEMBLY PREPARED THEREFROM AND FUEL CELL COMPRISING THE SAME

(75) Inventors: Eun Ae Cho, Seoul (KR); Seok Hui Im, Gyeonggi-do (KR); Tae Hoon Lim, Seoul (KR); In Hwan Oh, Seoul (KR); Suk-Woo Nam, Seoul (KR); Sung Pil Yoon, Gyeonggi-do (KR); Sang Yeop Lee, Seoul (KR); Hyoung-Juhn Kim, Gyeonggi-do (KR); Jong Hyun Jang, Gyeonggi-do (KR); Soo-Kil Kim, Seoul (KR)

(73) Assignee: KOREA INSTITUTE OF SCIENCE AND TECHNOLOGY, Seoul (KR)

(21) Appl. No.: 13/319,371

(22) PCT Filed: Oct. 16, 2009
(86) PCT No.: PCT/KR2009/005961

§ 371 Date: Nov. 18, 2011

(30) Foreign Application Priority Data
May 8, 2009 (KR) 10-2009-0040398

(51) Int. Cl. H01M 8/10; B44C 1/17

(52) U.S. Cl. 429/492; 156/230; 429/479

(57) ABSTRACT

Provided is a method for producing a membrane-electrode assembly for a full cell, comprising: preparing catalyst ink slurry from a catalyst, an ion conductive polymer and a solvent; applying the catalyst ink slurry onto a support film, followed by vacuum drying; and transferring the support film to either surface or both surfaces of an electrolyte membrane to form a catalyst layer on the electrolyte membrane. A membrane-electrode assembly obtained by the method and a fuel cell including the membrane-electrode assembly are also provided. The method provides a membrane-electrode assembly having increased porosity, and thus the membrane-electrode assembly shows significantly reduced mass transfer resistance. Therefore, the output density and the quality of the fuel cell including the membrane-electrode assembly prepared therefrom can be improved.

### TECHNICAL FIELD

This disclosure relates to a method for producing a membrane-electrode assembly for a fuel cell, a membrane-electrode assembly obtained from the method, and a fuel cell including the membrane-electrode assembly. More particularly, this disclosure relates to a method for producing an electrolyte membrane-electrode assembly for a fuel cell capable of reducing mass transfer resistance of a membrane-electrode assembly, a membrane-electrode assembly obtained from the method, and a fuel cell having significantly improved output density and quality.

### BACKGROUND ART

Fuel cells are power generation systems in which chemical energy of hydrogen and oxygen contained in hydrocarbon-based materials, such as methanol, ethanol or natural gas, is converted directly into electric energy via electrochemical reactions.

Particularly, polymer electrolyte membrane fuel cells (PEMFC) are advantageous in that they have a relatively low driving temperature, high energy density, low corrosive property and easy handling characteristics, and thus have been regarded as clean and efficient energy conversion systems utilizable as mobile or fixed power sources.

A fuel cell system may include a continuous composite having a membrane-electrode assembly (MEA), a bipolar plate for collecting electricity generated therein and supplying fuel thereto, or the like.

A membrane-electrode assembly is obtained by coating a catalyst layer onto an electrolyte membrane to form an electrode in general. Methods for forming the catalyst layer may include a method for fixing an electrolyte membrane obtained after the pre-treatment and drying, followed by spraying slurry containing a catalyst dispersed therein thereto, a method for applying catalyst slurry onto a support to form a catalyst layer and transferring the catalyst layer to a polymer electrolyte membrane, or the like.

Meanwhile, the method for forming a catalyst layer directly onto an electrolyte membrane are problematic in that uniform application of a catalyst is difficult due to a change in the outer shape of an electrolyte membrane during the spraying process, particularly when using an electrolyte membrane, such as a Nafion membrane, having swelling property.

More particularly, the method for producing a membrane-electrode assembly via a transfer process includes applying a catalyst layer forming composition onto a polymer film, followed by drying, and transferring the resultant catalyst layer to an electrolyte membrane by way of hot pressing. Herein, the catalyst layer forming composition applied to the polymer film is dried at room temperature under ambient pressure (atmospheric pressure).

### DISCLOSURE OF INVENTION

### Technical Problem

However, the above drying process currently used in the transfer process has disadvantages in that it requires a long drying time, external temperature and humidity may affect the catalyst layer during the drying process, and the surface of the catalyst layer may be contaminated. In addition, the polymer electrolyte membrane on which the catalyst is applied after the drying process may not show a desired degree of porosity, resulting in a significant increase in the mass transfer resistance of the resultant membrane-electrode assembly. Furthermore, a fuel cell including the membrane-electrode assembly requires an increased amount of catalyst to provide a desired degree of output. However, since a fuel cell generally uses an expensive noble metal catalyst, such an increased amount of catalyst causes an increase in the cost needed to manufacture a fuel cell, and thus hinders commercialization of fuel cells.

Therefore, disclosed herein is a method for producing a membrane-electrode assembly that uses a decreased amount of noble metal catalyst, realizes high quality and shows low mass transfer resistance. Disclosed herein too are a membrane-electrode assembly obtained from the above method and a fuel cell including the above membrane-electrode assembly.

### Solution to Problem

In one aspect, there is provided a method for producing an electrolyte membrane-electrode assembly, including:

preparing catalyst ink slurry from a catalyst, an ion conductive polymer and a solvent; applying the catalyst ink slurry onto a support film, followed by vacuum drying; and transferring the support film to either surface or both surfaces of an electrolyte membrane to form a catalyst layer on the electrolyte membrane.

In another aspect, there is provided an electrolyte membrane-electrode assembly obtained by the above method.

In still another aspect, there is provided a fuel cell including the above electrolyte membrane-electrode assembly.

### Advantageous Effects of Invention

The method for producing a membrane-electrode assembly for a fuel cell disclosed herein enables production of a membrane-electrode assembly having significantly increased porosity. In addition, the electrolyte membrane-electrode assembly obtained by the above method shows significantly decreased mass transfer resistance. Further, the fuel cell including the above electrolyte membrane-electrode assembly provides significantly improved output density and quality.

### BRIEF DESCRIPTION OF DRAWINGS

The above and other aspects, features and advantages of the disclosed exemplary embodiments will be more apparent from the following detailed description taken in conjunction with the accompanying drawings in which:

FIG. 1 is a schematic view illustrating a structure used in the method for producing a membrane-electrode assembly according to one embodiment;

FIG. 2 and FIG. 3 are graphs showing the results of porosity increment measured in the unit cell obtained according to one embodiment of the method disclosed herein; and

FIG. 4 is a graph showing the quality of the unit cell obtained according to one embodiment of the method disclosed herein.

### BEST MODE FOR CARRYING OUT THE INVENTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

As demonstrated by the following examples, it has now been found that the membrane-electrode assembly for a fuel cell obtained by the method disclosed herein has high porosity and realizes excellent quality even though a relatively small amount of catalyst is loaded on the membrane-electrode assembly. In other words, the method for producing an electrolyte membrane-electrode assembly disclosed herein provides a membrane-electrode assembly that has high porosity and thus shows significantly reduced mass transfer resistance. As a result, it can be seen that a fuel cell including the above membrane-electrode assembly realizes significantly improved output density and quality.

To carry out the method for producing a membrane-electrode assembly disclosed herein, first of all, a catalyst, an ion conductive polymer and a solvent are mixed, followed by degassing, to provide catalyst ink slurry.

As the catalyst, platinized carbon (Pt/C) may be used, and Pt in the catalyst specifically may be used in an amount of 40-50 wt % based on the total weight of the catalyst.

To provide the catalyst ink slurry, the ion conductive polymer may be mixed with the solvent to form an ion conductive polymer solution.

As the ion conductive polymer, Nafion (available from Dupont) based on perfluorosulfonic acid or hydrocarbon-based polymer electrolyte may be used. More particularly, Nafion ionomers may be used.

The solvent may be at least one solvent selected from the group consisting of iso-propanol, n-propanol, ethanol, methanol, water and n-butyl acetate, but is not limited thereto.

In one embodiment, the catalyst ink slurry may include 3-10 wt % of the catalyst, 1-5 wt % of the ion conductive polymer and 75-96 wt % of the solvent, based on the total weight of the slurry.

Particularly, in order to provide the catalyst ink slurry, the solvent is first added to the Pt/C catalyst (e.g. 45.5 wt %), a desired equivalent weight (EW, e.g. 1100) of Nafion ionomer is added thereto in a desired amount (e.g. about 21 wt % of the dispersion), and the resultant mixture is subjected to ultrasonification at room temperature. The slurry may further mixed homogeneously by a homogenizer. Herein, the catalyst ink slurry may be maintained at a constant internal temperature.

After the catalyst, ion conductive polymer and solvent are mixed, the resultant mixture is subjected to degassing. Although there is no particular limitation in the degassing work, it may be carried out at a temperature of 20-60° C. under vacuum, specifically at room temperature under vacuum of 760 mmHg for 10 minutes.

Next, the catalyst ink slurry is applied onto a support film, followed by vacuum drying.

As the support film, at least one polymer film selected from the group consisting of polytetrafluoroethylene (PTFE), perfluoroalkoxy (PFA), fluorinated ethylene propylene (FEP), polyvinylidene fluoride (PVdF), polypropylene (PP), polyimide (PI), polyethylene (PE), polycarbonate (PC) and polyethylene terephthalate (PET) may be used. Such polymer films may be used alone or in combination. The polymer film may further include glass fibers. Alternatively, aluminum foil may be used.

The polymer film may be a non-porous or porous film. The porous support film may have a pore size of 50 nm-100 μm and a porosity of 5-90%. The polymer film used as the support film may have a thickness of 10 μm-1 mm.

To apply the catalyst ink slurry onto the support film, at least one process selected from the group consisting of spray coating, screen printing, tape casting, brushing and slot die casting may be used, but is not limited thereto.

Herein, the catalyst ink slurry is dried via vacuum drying. Particularly, the drying temperature may be 20-60° C. It has now been found that such a drying condition improves the porosity of a membrane-electrode assembly, reduces the amount of catalyst loaded on the membrane-electrode assembly, and thus significantly reduces the mass transfer resistance of an electrode.

Then, the support film is transferred to either surface or both surfaces of an electrolyte membrane to form a catalyst layer on the electrolyte membrane.

The transfer work may be carried out by stacking the support film coated with the catalyst ink slurry on the electrolyte membrane, followed by hot pressing. Herein, hot pressing may be performed at a temperature of 100-140° C. under a pressure of 100-200 kgf/cm².

When forming the catalyst layer via hot pressing at high temperature under high pressure, an additional electrolyte membrane fixing film (that may be formed of the same material as the support film) may be disposed on either surface or both surfaces of the electrolyte membrane that is not subjected to catalyst layer transfer, so that the electrolyte membrane may not be moved or deformed during the hot pressing.

Although there is no particular limitation in the electrolyte membrane, the electrolyte membrane may be at least one selected from the group consisting of perfluorosulfonic acid polymers, perfluorocarbon sulfonic acid polymers, hydrocarbon polymers, polyimides, polyvinylidene fluoride, polyether sulfone, polyphenylene sulfide, polyphenylene oxide, polyphosphazene, polyethylene naphthalate, polyester, doped polybenzimidazole, polyether ketone, polysulfone, and acids and bases thereof. The electrolyte membrane may have a thickness of about 20-200 μm, specifically 40-60 μm.

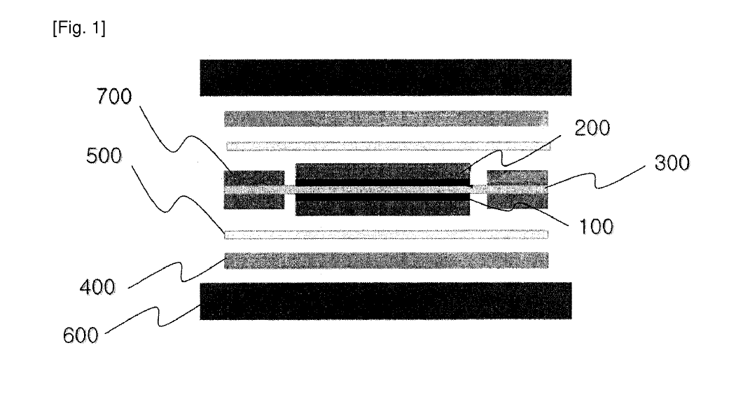

More particularly, the structure as shown in FIG. 1 may be used to form a catalyst layer. A stainless steel plate 400, a gasket 500, catalyst ink slurry 100 coated on a support film 200, a Nafion 112 electrolyte membrane 300, an electrolyte membrane fixing film 700 and a hot pressing plate 600 are successively stacked, and the stacked structure is disposed on the center of a heated hot pressing device. Then, hot pressing may be performed for about 2-10 minutes to form a catalyst layer.

After the hot pressing, the structure as shown in FIG. 1 is cooled and the stainless steel plate 400, the gasket 500, the support film 200, the electrolyte membrane fixing film 700 and the hot pressing plate 600 are removed to obtain an electrolyte membrane having a catalyst layer. Herein, the catalyst layer may have a thickness of 5-20 μm.

In another aspect, there is provided a membrane-electrode assembly obtained by the above-described method. The electrode in the membrane-electrode assembly disclosed herein may have a porosity of 20-40%. Such porosity is higher than the porosity of an electrode obtained after drying it at room temperature under ambient pressure (atmospheric pressure) as measured by a mercury porosimeter. Therefore, it is possible to provide the electrode with reduced mass transfer resistance.

In still another aspect, there is provided a fuel cell including the above-described membrane-electrode assembly. The fuel cell may be a polymer electrolyte membrane fuel cell (PEMFC).

The fuel cell disclosed herein includes the membrane-electrode assembly that shows reduced mass transfer resistance, and thus realizes excellent output density and quality even in the presence of a small amount of catalyst.

### Mode for the Invention

The examples and experiments will now be described. The following examples and experiments are for illustrative purposes only and not intended to limit the scope of this disclosure.

### EXAMPLE

### Fabrication of Membrane-Electrode Assembly

1. Pt/C Catalyst Ink Slurry Blending

Pt/C catalyst ink slurry is prepared according to the composition as shown in Table 1.

TABLE 1

| Ingredient | Unit (g) |
|---|---|
| Pt/C (45.5 wt %. Tanaka) | 1.0000 g |
| Deionized water (D.I.W) | 9.5000 g |
| Nafion dispersion (EW 1100)-Total | 2.0500 g |
| Nafion ionomer | 0.4305 g |
| 1-propanol | 0.9020 g |
| Water | 0.7175 g |
| Isopropyl alcohol (IPA) | 7.4000 g |
| Solid content | 7.17 |
| Ratio of IPA/Water + D.I.W | 0.8125 |

First, 1 g of Pt/C (45.5 wt %, Tanaka) is introduced into a 25 mL vial container.

Next, 9.5 g of deionized water (D.I.W) is added thereto, and then 7.4 g of isopropyl alcohol (IPA) is further added thereto.

Then, the vial container is sealed with a cap and ultrasonification is carried out at room temperature for 10 minutes.

After that, while 0.435 g of Nafion ionomer (21 wt % of the total dispersion) is dispersed into 0.9020 g of 1-propanol and 0.7175 g of water, 2.05 g of dispersion (IPA/water+D.I.W. is 0.8125, and the solid content is 7.17 as defined by the ratio of combined weight of the catalyst and Nafion ionomer/combined weight of water and IPA) of Nafion ionomer (EW 1100) formed by adding 7.4000 g of IPA is added thereto.

Then, the vial container is sealed with a cap and ultrasonification is carried out at room temperature for 10 minutes.

Finally, the vial container including the Pt/C catalyst ink slurry is agitated by a homogenizer. Herein, the homogenizer is maintained at 13,000 rpm for 120 minutes. In addition, a circulator is used so that the Pt/C catalyst ink slurry is maintained at a constant internal temperature during the agitation.

2. Degassing

After the agitation, the Pt/C catalyst ink slurry is introduced into a vacuum oven and subjected to degassing at room temperature under vacuum of 760 mmHg for 10 minutes.

3. Coating and Drying

The Pt/C catalyst ink slurry is coated on a 50 μm Kapton film (polyimide film available from Dupont) cut into an adequate size via a doctor blade coating process.

Then, the Kapton film coated with the Pt/C catalyst ink slurry is dried in a vacuum oven at 30° C. under vacuum of 760 mmHg for 24 hours.

4. Hot Pressing

As shown in FIG. 1, a stainless steel plate (11 cm×11 cm), an electrolyte membrane fixing film (5 μm, Kapton film), a gasket (11 cm×11 cm), a catalyst layer (5 cm×5 cm) joined with a support film, and a Nafion 112 membrane (11 cm×11 cm) are successively stacked.

Next, the structure as shown in FIG. 1 is disposed on the center of a hot pressing device heated to 140° C., and hot pressing is carried out under a pressure of 160 kgf/cm² for 4 minutes.

Then, the structure is removed from the hot pressing device, followed by cooling to room temperature.

After that, the stainless steel plate, the electrolyte membrane fixing film and the support films on both sides of the catalyst layer are removed to obtain a catalyst layer with a thickness of 10 μm or less.

### COMPARATIVE EXAMPLE

A membrane-electrode assembly is obtained in the same manner as described in

Example, except that the Kapton film coated with the Pt/C catalyst ink slurry is dried under the condition of room temperature/ambient pressure for 24 hours.

### Experimental Example 1

### Measurement of Pt Loading Amount

As shown in Table 2, the loading amount of Pt coated on the cathode and an anode of each membrane-electrode assembly is calculated as follows: the weight (g) of the support film removed after the hot pressing is subtracted from the weight (g) of a sheet of the structure having the coating layer dried on the support film before the hot pressing and cut into a size of 5 cm×5 cm, the resultant weight is multiplied by 1000 for the expression in the unit of mg, and then the resultant value (mg) is divided by the active area (25 cm²) to obtain the catalyst loading amount per unit area. Herein, the weight of the catalyst except the Nafion ionomer is calculated by a multiplying factor of 0.7 (This is because the amount of Nafion ionomer is 0.43 g corresponding to 21 wt % of the Nafion ionomer dispersion, the total solid content including the catalyst (1.00 g) becomes 1.43 g, and thus the catalyst occupies 70 wt % of the total solid content). Since Pt occupies 45.5 wt % of the total catalyst weight, the Pt loading amount of each membrane-electrode assembly is calculated by a multiplying factor of 0.455. The results of the Pt loading amount are shown in Table 2.

TABLE 2
Pt loading

| | Cathode (mg/cm²) | Anode (mg/cm²) |
|---|---|---|
| Comp. Ex. | 0.3465 | 0.3210 |
| Ex. | 0.3312 | 0.3134 |

As shown in Table 2, the Pt loading amount of the membrane-electrode assembly according to Example is lower than that of the membrane-electrode assembly according to Comparative Example. Particularly, according to Example, the cathode Pt loading amount and the anode Pt loading amount are about 4.6% and about 2.4% lower than those amounts according to Comparative Example, respectively.

### Experimental Example 2

### Measurement of Porosity of Unit Cell

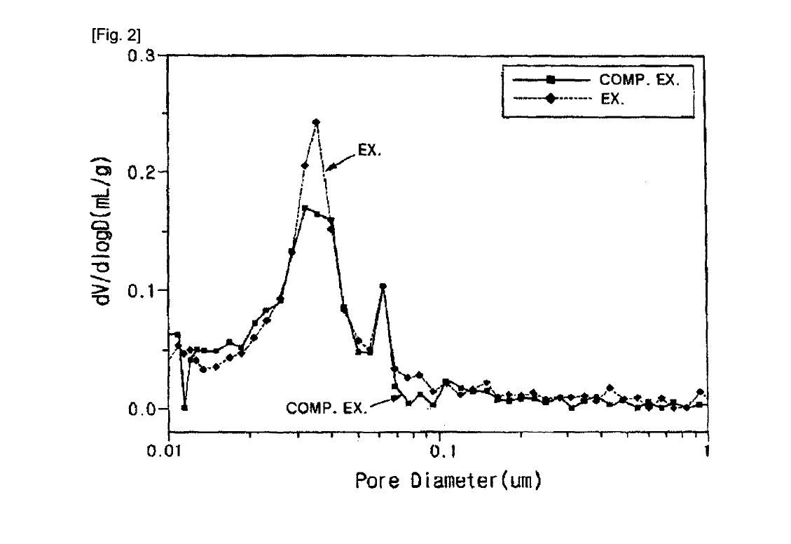

The porosity of each membrane-electrode assembly (MEA) obtained from Example and Comparative Example is measured by a mercury porosimeter. Each sample MEA is cut into a size of 2 cm×2 cm to perform analysis. The results are shown in FIG. 2 and FIG. 3. As shown in FIG. 2 and FIG. 3, the MEA subjected to vacuum drying shows significantly increased porosity as compared to the MEA subjected to drying at room temperature under ambient pressure (atmospheric pressure).

### Experimental Example 3

### Evaluation of Quality of Unit Cell

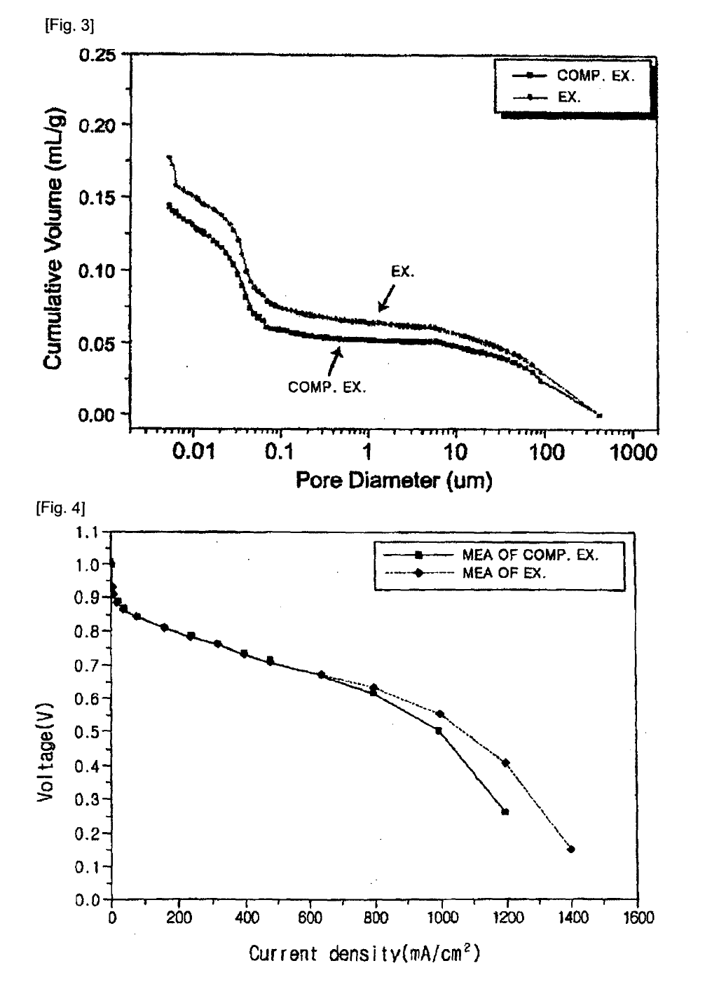

The MEAs obtained from Example and Comparative Example are used to provide unit cells and the quality of each unit cell is evaluated. The results are shown in FIG. 4.

To evaluate the quality of each unit cell, the anode is set to a humidifier temperature of 71° C., a line heater temperature of 81° C. and a dew point of 64.3° C., and the cathode is set to a humidifier temperature of 69° C., a line heater temperature of 79° C. and a dew point of 64.5° C. Each unit cell is evaluated under a relative humidity of 100% in a constant current mode.

As can be seen from FIG. 4, although the Pt loading amount of the MEA of Example is lower than that of the MEA of Comparative Example, the unit cell of Example provides improved quality, and shows reduced mass transfer resistance.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1. A method for producing an electrolyte membrane-electrode assembly, comprising:
preparing catalyst ink slurry from a catalyst, an ion conductive polymer and a solvent;
applying the catalyst ink slurry onto a support film, followed by vacuum drying; and
transferring the support film to either surface or both surfaces of an electrolyte membrane to form a catalyst layer on the electrolyte membrane.

2. The method for producing an electrolyte membrane-electrode assembly according to claim 1, wherein the catalyst is platinized carbon powder (Pt/C).

3. The method for producing an electrolyte membrane-electrode assembly according to claim 1, wherein the ion conductive polymer is a Nafion ionomer.

4. The method for producing an electrolyte membrane-electrode assembly according to claim 1, wherein the solvent is at least one selected from the group consisting of isopropanol, n-propanol, ethanol, methanol, water and n-butyl acetate.

5. The method for producing an electrolyte membrane-electrode assembly according to claim 1, wherein the catalyst ink slurry comprises 3-10 wt % of the catalyst, 1-5 wt % of the ion conductive polymer and 75-96 wt % of the solvent, based on the total weight of the slurry.

6. The method for producing an electrolyte membrane-electrode assembly according to claim 1, wherein the catalyst ink slurry is prepared by mixing the catalyst, the ion conductive polymer and the solvent, followed by degassing, and the degassing is performed at 20-60° C. under vacuum.

7. The method for producing an electrolyte membrane-electrode assembly according to claim 1, wherein the vacuum drying is carried out at 20-60° C.

8. The method for producing an electrolyte membrane-electrode assembly according to claim 1, wherein the catalyst ink slurry is applied onto the support film via at least one process selected from the group consisting of spray coating, screen printing, tape casting, brushing and slot die casting.

9. The method for producing an electrolyte membrane-electrode assembly according to claim 1, wherein the support film is at least one polymer film selected from the group consisting of polytetrafluoroethylene (PTFE), perfluoroalkoxy (PFA), fluorinated ethylene propylene (FEP), polyvinylidene fluoride (PVdF), polypropylene (PP), polyimide (PI), polyethylene (PE), polycarbonate (PC) and polyethylene terephthalate (PET).

10. The method for producing an electrolyte membrane-electrode assembly according to claim 1, wherein the catalyst layer has a thickness of 5-20 μm.

11. The method for producing an electrolyte membrane-electrode assembly according to claim 1, wherein the electrolyte membrane is at least one selected from the group consisting of perfluorosulfonic acid polymers, perfluorocarbon sulfonic acid polymers, hydrocarbon polymers, polyimides, polyvinylidene fluoride, polyether sulfone, polyphenylene sulfide, polyphenylene oxide, polyphosphazene, polyethylene naphthalate, polyester, doped polybenzimidazole, polyether ketone, polysulfone, and acids and bases thereof.

12. The method for producing an electrolyte membrane-electrode assembly according to claim 1, wherein the catalyst layer is formed on the electrolyte membrane by stacking the support film coated with the catalyst ink slurry on the electrolyte membrane, and carrying out hot pressing by applying a pressure of 100-200 kgf/cm2 at 100-140° C.

13. The method for producing an electrolyte membrane-electrode assembly according to claim 1, wherein an electrolyte membrane fixing film is disposed on either surface or both surfaces of the electrolyte membrane that is not subjected to catalyst layer transfer, and the catalyst layer transfer is performed by fixing the electrolyte membrane with the electrolyte membrane fixing film.

14. The method for producing an electrolyte membrane-electrode assembly according to claim 1, which further comprises cooling the electrolyte membrane having the catalyst layer formed thereon, and removing the support film from the catalyst layer.

15. An electrolyte membrane-electrode assembly obtained by the method according to claim 1.

16. The electrolyte membrane-electrode assembly according to claim 15, wherein the electrode has a porosity of 20-40%.

17. A fuel cell comprising the electrolyte membrane-electrode assembly according to claim 15.

18. The fuel cell according to claim 17, which is a polymer electrolyte membrane fuel cell (PEMFC).
